(19) United States
(12) Patent Application Publication
(10) Pub. No.: US 2011/0183072 A1
(43) Pub. Date: Jul. 28, 2011

(54) HOT-DIP GALVANIZATION SYSTEMS AND METHODS

(75) Inventors: Kevin Carroll, Long Beach, CA (US); Sam Sagae, Long Beach, CA (US); Thomas Tuan Nguyen, Walnut, CA (US); Sherman Dean Anderson, Pala, CA (US)

(73) Assignee: Western Tube & Conduit Corporation

(21) Appl. No.: 12/695,970

(22) Filed: Jan. 28, 2010

(51) Int. Cl. B05D 3/10; B05C 9/10; B05C 3/02

(52) U.S. Cl. 427/299; 118/69

(57) ABSTRACT

A method for hot-dip galvanizing metal tubes, may include placing a rack of metal tubes in an acid bath; removing the rack of metal tubes from the acid bath; placing the rack of metal tubes in a molten bath; removing the rack of metal tubes from the molten bath; and quenching the rack of metal tubes in a shower. The rack of steel tubes may be placed in the molten bath immediately after the rack is removed from the acid bath without further processing therebetween

### BACKGROUND

1. Field of the Invention

Embodiments of the present invention generally relate to hot-dip galvanization systems and methods, and, in specific embodiments, to hot-dip galvanization systems and methods of metal tubes, conduits, or the like.

2. Related Art

Hot-dip galvanization is the application of zinc or iron/zinc alloy coatings by immersing prepared steel in molten zinc. A prior art discontinuous method is shown in FIG. 9. In the discontinuous method, it is essential for hot-dip galvanizing, namely the iron-zinc reaction, that the steel surface to be galvanized shall be metallically clean, i.e., free from grease, rust, and scale. This high level of surface preparation—level Be according to EN ISO 12944-4—is achieved by first conditioning the material to be galvanized in acid or alkali degreasing baths, then pickling in diluted hydrochloric acid, followed by fluxing. When the part to be galvanized is immersed in the zinc bath (between 440° and 460° C.), the flux, which is usually a mixture of zinc chloride and ammonium chloride, protects the metallic surface and improves its wettability as regards the molten zinc.

Zinc is the main component of the zinc bath, and the total amount of additional elements (with the exception of iron and tin) shall not exceed the sum of 1.5%. The cleansed and fluxed part can be dried prior to galvanization in an oven at temperatures between 80° and 100° C. During immersion in the zinc bath, layers of iron-zinc alloys build up on the surface of the steel element that is generally covered with a coat of pure zinc upon removal from the bath.

The speed of the iron-zinc reaction depends on the galvanizing parameters and the chemical composition of the steel, particularly its silicon and phosphorus content. “Reactive steels” build up thick layers of iron-zinc alloys and the residual heat in the galvanized material can even transform the pure zinc coat into a coat of iron-zinc alloy. This reaction can be interrupted or slowed down considerably by an immediate quenching of the galvanized part in a water bath.

However, the prior art method is not suitable for hot-dip galvanizing tubes, conduits, or the like. For instance, hot-dip galvanizing a tube would produce a rough interior that will strip or otherwise harm wiring later placed within the tube. Thus, only methods that produce a smooth interior within the tubes are suitable. Furthermore, the prior art includes a large number of steps each of which increases time and cost of processing the material.

### SUMMARY OF THE DISCLOSURE

A method for hot-dip galvanizing metal tubes may include, but is not limited to, any one of or combination of: (i) placing a rack of metal tubes in an acid bath; (ii) removing the rack of metal tubes from the acid bath; (iii) placing the rack of metal tubes in a molten bath; (iv) removing the rack of metal tubes from the molten bath; and (v) quenching the rack of metal tubes in a shower. The rack of metal tubes may be placed in the molten bath immediately after the rack is removed from the acid bath without further processing therebetween

### BRIEF DESCRIPTION OF THE DRAWINGS

FIG. 1 shows a flowchart of a process for hot-dip galvanization of a metal according to an embodiment of the present invention;

FIG. 2 shows a flowchart of processing performed while a rack is in a molten zinc bath according to an embodiment of the present invention;

FIG. 3 shows a flowchart of processing performed to remove a rack from a molten zinc bath according to an embodiment of the present invention;

FIG. 4 shows a system 10 for hot-dip galvanization of a metal according to an embodiment of the present invention;

FIG. 5 is a rear view cross-section of a rack and molten zinc bath according to an embodiment of the present invention;

FIG. 6 is a side view cross-section of a rack and molten zinc bath according to an embodiment of the present invention;

FIG. 7A is a side view cross-section of a rack and molten zinc bath according to an embodiment of the present invention;

FIG. 7B is a side view cross-section of a rack and molten zinc bath according to an embodiment of the present invention;

FIG. 7C is a side view cross-section of a rack and molten zinc bath according to an embodiment of the present invention;

FIG. 7D is a side view cross-section of a rack and molten zinc bath according to an embodiment of the present invention;

FIG. 7E is a side view cross-section of a rack and molten zinc bath according to an embodiment of the present invention;

FIG. 8 is a side view cross-section of a rack in a shower system according to an embodiment of the present invention; and

FIG. 9 shows the discontinuous galvanization process known in the prior art.

### DETAILED DESCRIPTION

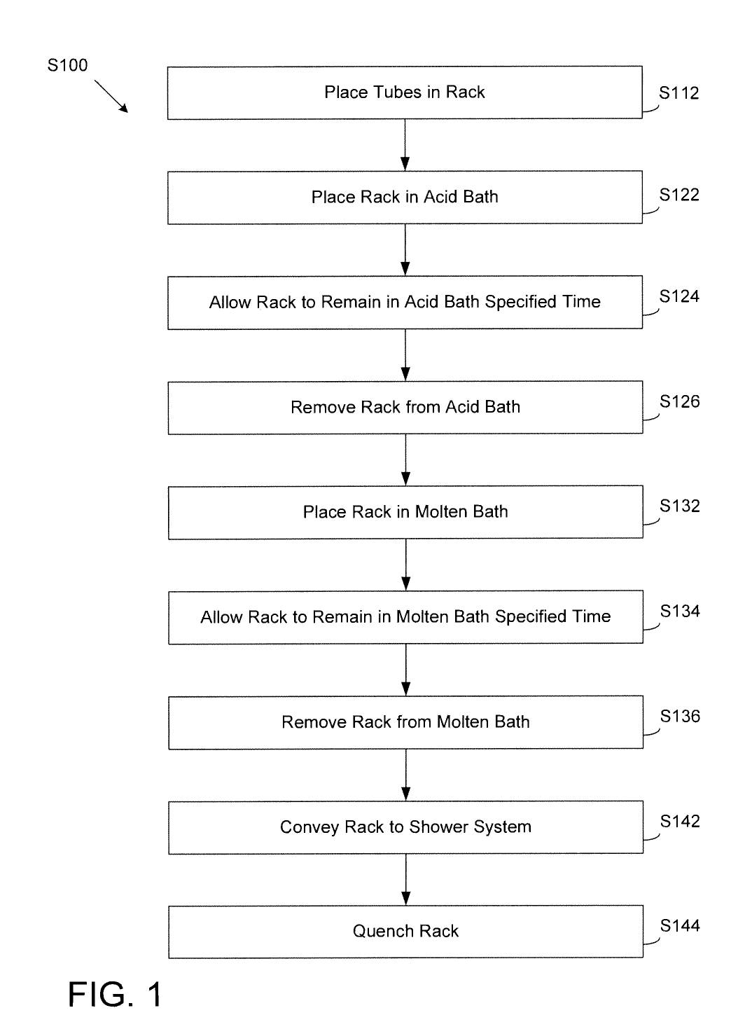

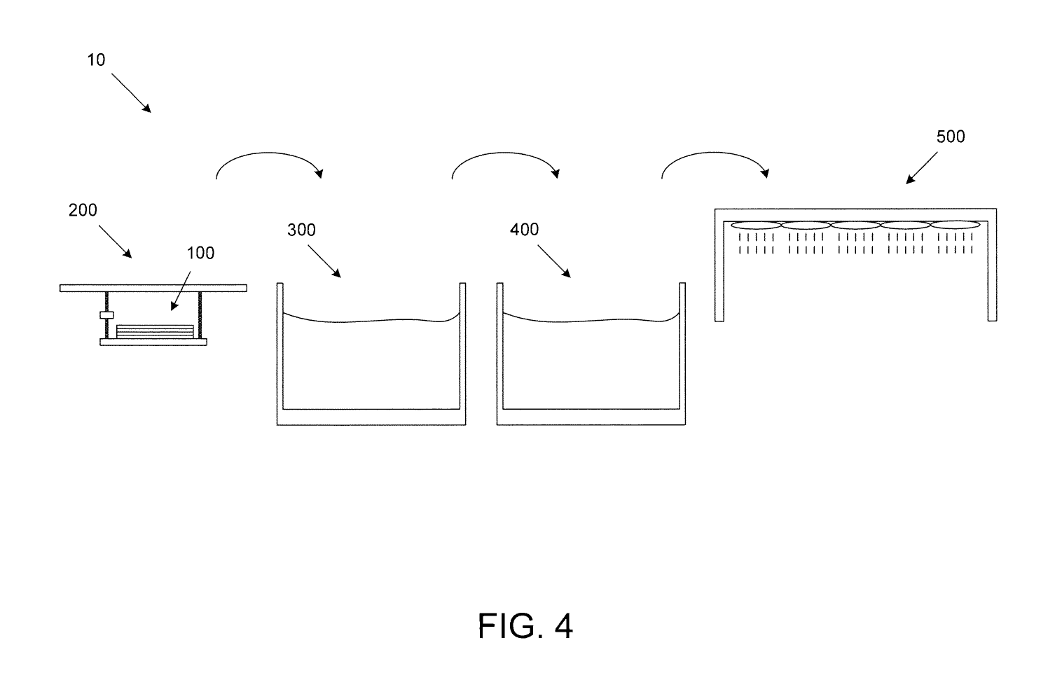

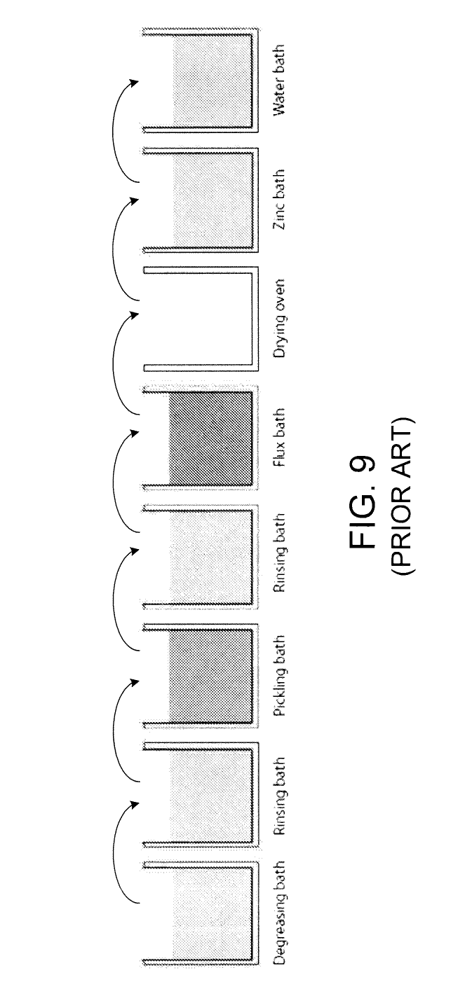

FIGS. 1-3 are directed to a method for hot-dip galvanizing steel tubes or the like, and may include (but is not limited to) placing a rack of steel tubes in an acid bath; removing the rack of steel tubes from the acid bath; placing the rack of steel tubes in a molten zinc bath; removing the rack of steel tubes from the molten zinc bath; and quenching the rack of steel tubes in a shower. FIGS. 4-8 are directed to a system for hot-dip galvanizing steel tubes or the like. Thus, various embodiments are directed to methods and systems for hot-dip galvanizing steel tubes or the like having substantially smooth exterior and interior surfaces, which is not possible using the prior art method (e.g., FIG. 9). Furthermore, specific embodiments are directed to methods and systems for hot-dip galvanizing steel tubes or the like having fewer steps or elements than the prior art method. For example, as discussed in greater detail below, in some embodiments, steel tubes can be processed without using flux after the tubes are removed from an acid bath and prior to placement in a molten zinc bath. As another example, in some embodiments, steel tubes can be processed without being placed in an alkaline bath or the like. In a further example, in various embodiments, the steel tubes can be quenched in a shower system as opposed to a water bath. In the prior art method, however, each of these steps are required, while throughout various embodiments discussed in the disclosure, these steps may be omitted or optionally included, if desired.

FIG. 1 shows a flowchart of a process S100 for hot-dip galvanization of a metal according to an embodiment of the present invention. FIG. 4 shows a system 10 for hot-dip galvanization of a metal according to an embodiment of the present invention. With reference to FIGS. 1 and 4, First, in step S112, metal material, such as, but not limited to, steel tubes 100 or the like, is placed in a rack 200, tub, or other fixture to facilitate movement thereof by a hoisting mechanism (e.g., crane) through several process areas. It should be noted that throughout the disclosure, the elements the rack 200 and the tubes 100 (supported on the rack 200) may be used interchangeably unless specifically noted otherwise.

In other embodiments, the material may be any material suitable for hot-dip galvanization. In various embodiments, the steel tubes 100 may be made of a material having a silicon content less than approximately 0.06%. In particular preferred embodiments, the steel tubes may be made of a material having a silicon content less than approximately 0.04%.

In step S122, the rack 200 is placed in an acid bath 300, such as hydrochloric acid or sulfuric acid, or the like. In step S124, the rack 200 remains in the acid bath 300, for example, to remove any scale or flash rust on the tubes 100 of the rack 200. Acid in the acid bath 300 has a concentration (by weight) of 10-15%. In various embodiments, the rack 200 remains in the acid bath 300 anywhere from 12 to 30 minutes. In particular embodiments, the rack 200 remains in the acid bath 300 anywhere from 15 to 30 minutes.

Next in step S126, the rack 200 is removed from the acid bath 300. Generally, the tubes 100 in the rack 200 should be conveyed to a molten zinc bath following removal from the acid bath 300 in less than 5 minutes. In particular embodiments, the tubes 100 in the rack 200 should be conveyed to a molten zinc bath following removal from the acid bath 300 in less than 2 minutes to minimize oxidization and blistering of the tubes 100.

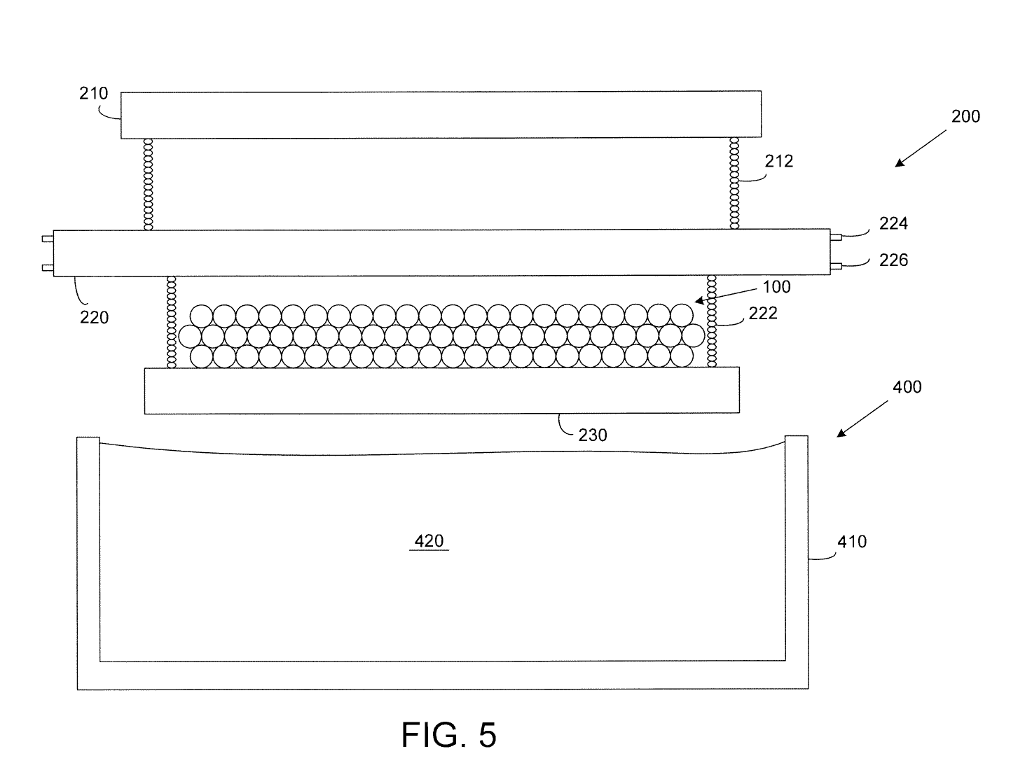

FIGS. 5-7D show a cross section of the rack 200 and a molten zinc bath 400 according to an embodiment of the present invention. In step S132, the rack 200 is placed in a kettle 410 containing molten zinc 420. The molten zinc 420 has a temperature of about 830-860° F. In particular embodiments, the temperature of the molten zinc 420 is about 850° F. In some embodiments, the molten zinc bath 400 contains substantially only zinc. However, in other embodiments, the molten zinc bath 400 contains additional metals or the like. In yet other embodiments, a molten bath may include any other suitable metal or the like, such as lead, antimony, tin, aluminum, or the like.

In some embodiments, a rate at which the rack 200 is placed in the molten zinc bath 400 is controlled. Such embodiments, for instance, may minimize formation of ash on or around the tubes 100. The rack 200 may be placed into the molten zinc bath 400 at a rate of 3-5 feet/minute. In particular embodiments, the rack 200 may be placed in the molten zinc bath 400 at a rate of 4 feet/minute.

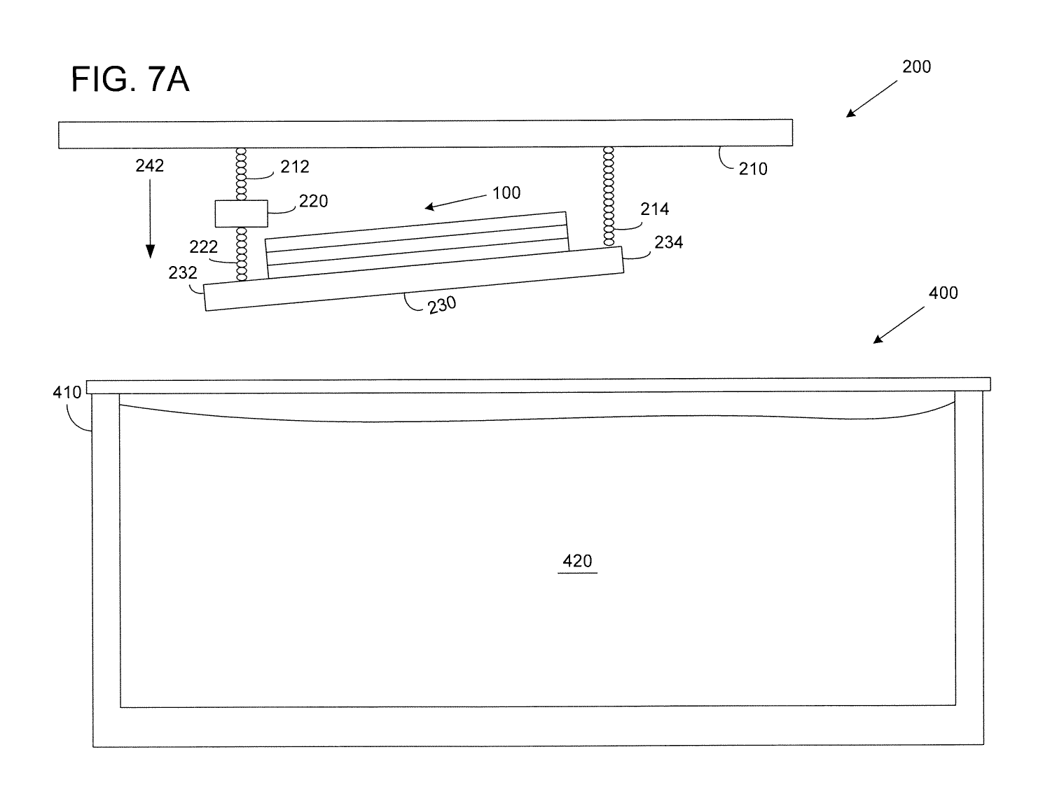

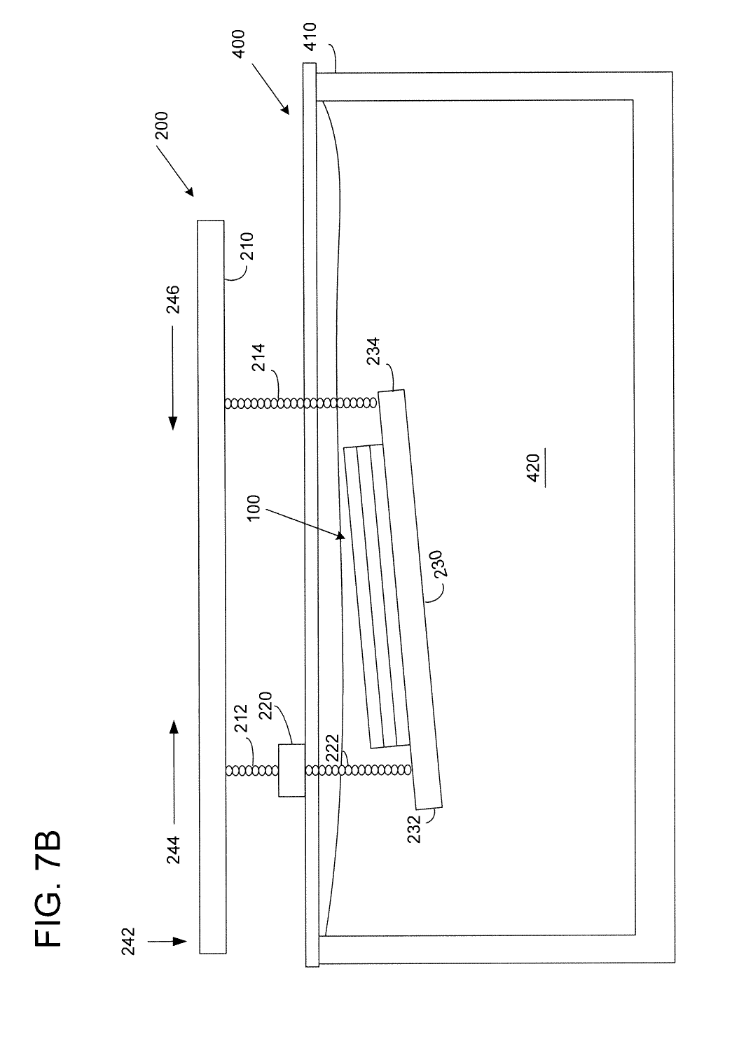

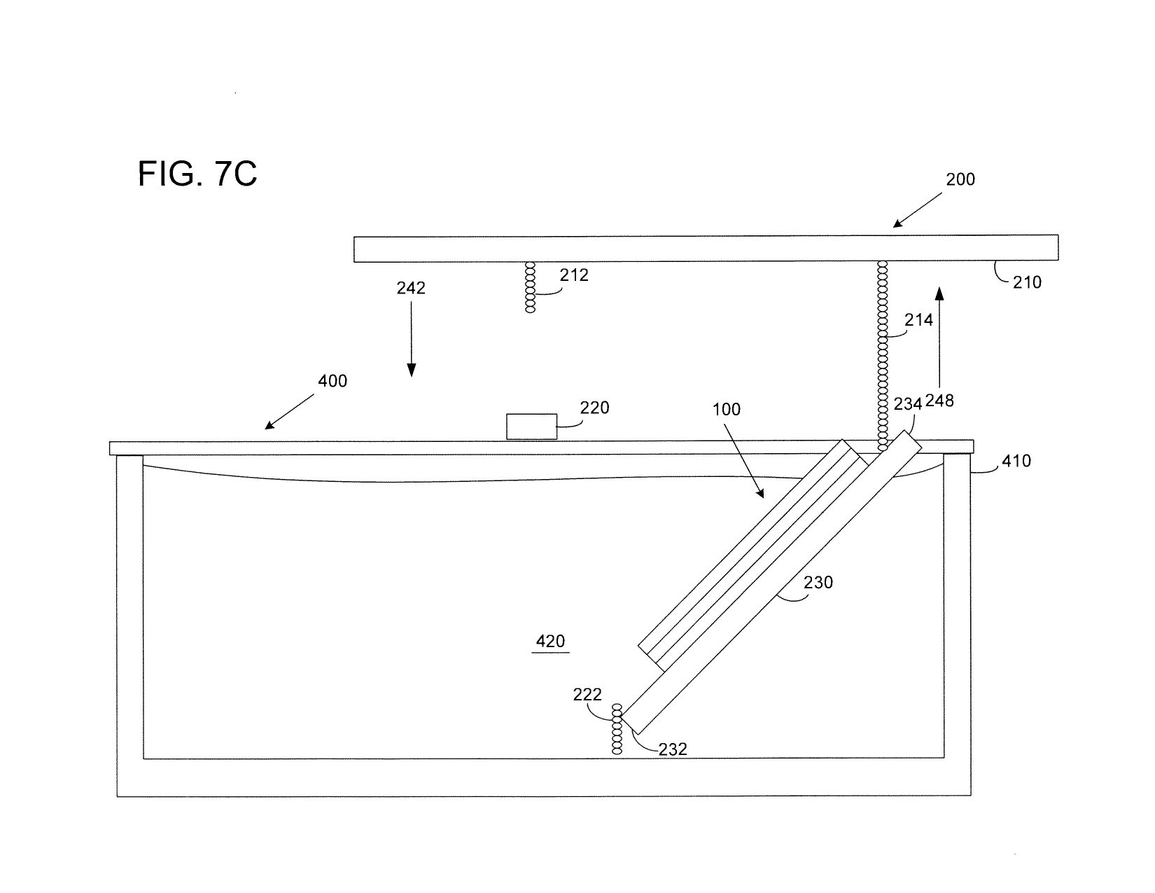

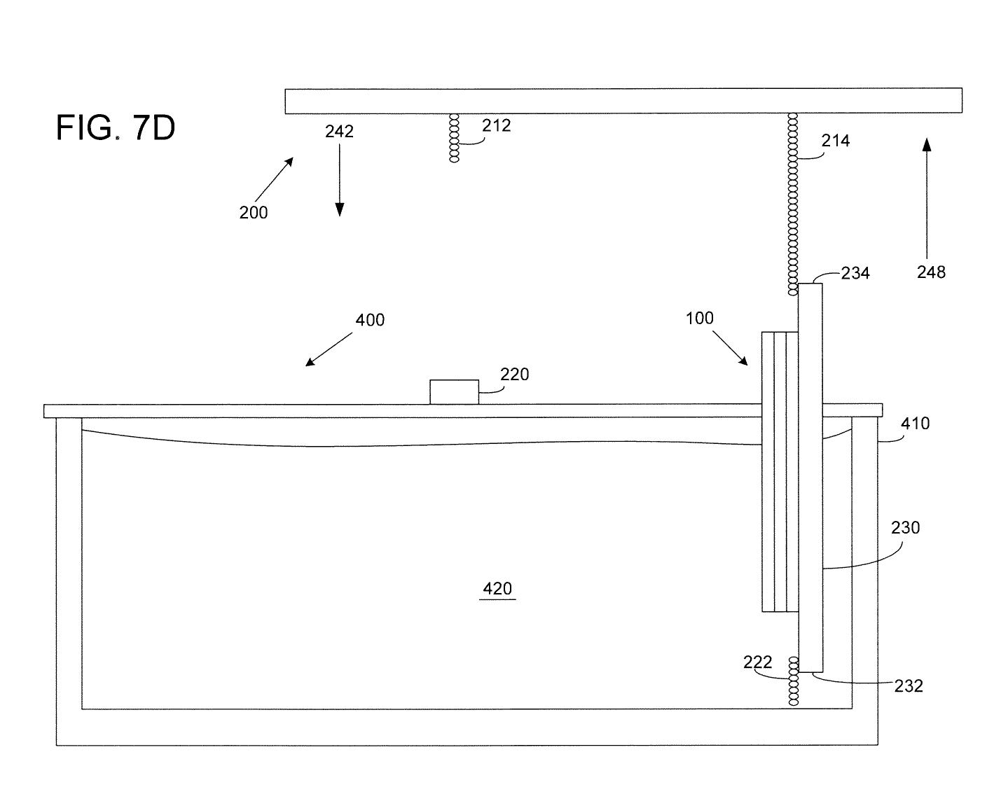

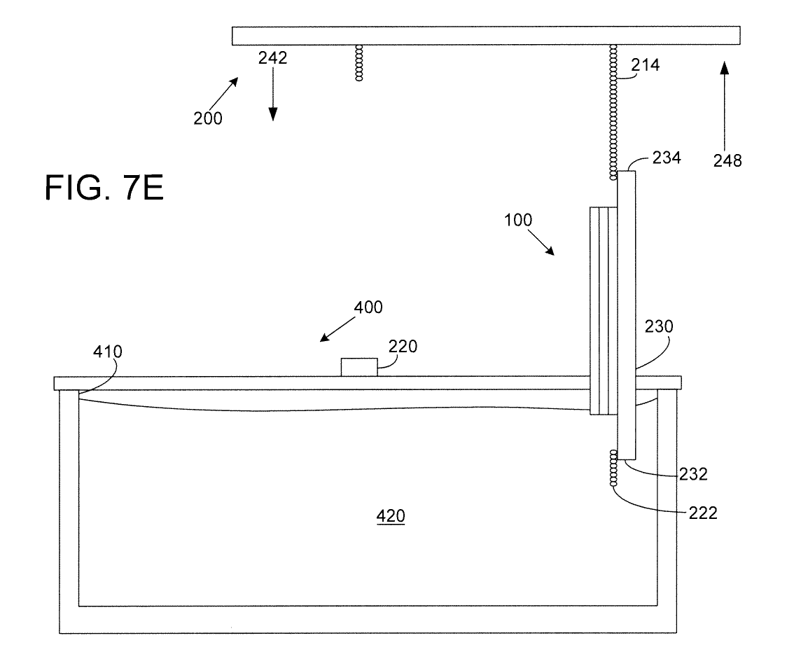

In particular embodiments, the rack 200 is placed in the molten zinc bath 400 (in direction 242 of FIG. 7A) immediately after removal from the acid bath 300 without any further processing steps (e.g., placing the rack 200 in a flux bath) in between. In such embodiments and unlike the prior art, the rack 200 is not placed in a flux bath (e.g., FIG. 9) prior to placement in the molten zinc bath 400 because the tubes 100 are conveyed to the molten zinc bath 400 in a relatively short period (e.g., under 2 minutes) to prevent oxidization, which may otherwise prevent proper bonding of the zinc.

Furthermore, omission of the flux bath step may be advantageous because the flux may lead to formation of solid deposits, such as zinc chloride or ammonium chloride, which when combined with water become an acid that could comprise the integrity of the tubes 100. Moreover, the flux bath needs to be heated, which increases energy consumption, and thus cost. In addition, methods (e.g., prior art shown in FIG. 9) that include a flux bath also require a rinse bath in which the tubes 100 are placed following removal from the acid bath 300. Such a rinse bath results in increased treatment and disposal costs.

However, in other embodiments, the rack 200 alternatively may be placed in a flux bath and/or otherwise be processed (e.g., placed in a rinse bath) after being removed from the acid bath 300 and prior to placement in the molten zinc bath 400. Such embodiments may be employed, for example, in a case where the rack 200 is not placed in the molten zinc bath 400 soon (e.g., under 2 minutes) after removal from the acid bath 300.

Once submerged in the molten zinc bath 400, the steel tubes 100 remain in the molten zinc bath 400 sufficient time to equalize temperature of the steel tubes 100 with the temperature of the molten zinc 420 (step S134 in FIG. 7B). Generally, the time necessary to equalize the temperature of the steel tubes 100 with the temperature of the molten zinc 420 (e.g., 850° F.) is between approximately 5-12 minutes. In particular embodiments, the steel tubes 100 remain in the molten zinc bath 400 approximately 9 minutes. In other embodiments, the rack 200 may remain in the molten zinc bath 400 any suitable time that would not result in insufficient or excess formation of alloy on the tubes 100.

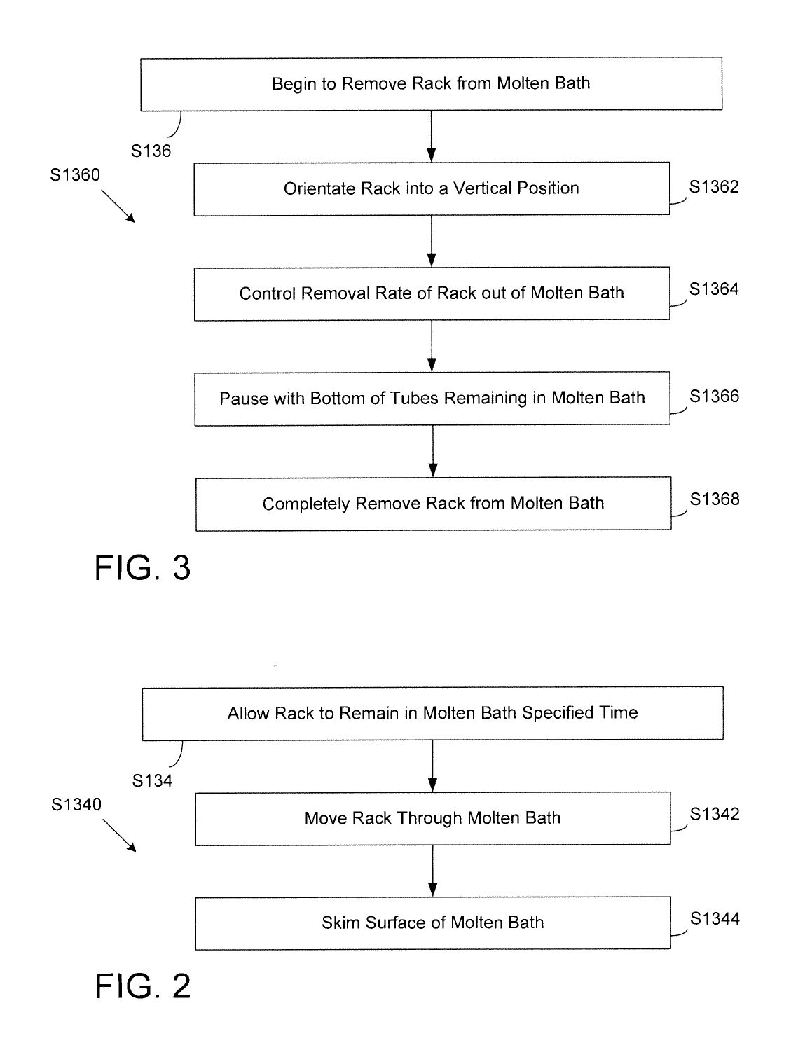

FIG. 2 shows a flowchart of processing S1340 performed while the rack 200 is in the molten zinc bath 400 according to an embodiment of the present invention. With reference to FIGS. 2 and 5-7D, in some embodiments, while the rack 200 is submerged in the molten zinc bath 400 (S134), in step S1342, the rack 200 is swung back (direction 246) and forth (direction 244) in the molten zinc bath 400 in a swinging motion. The swinging motion of the rack 200 causes a fluid motion to aid in flushing out ash and dross within the tubes 100. Thus, in some embodiments, the tubes 100 are moved in an axial direction of the tubes. A speed at which the rack 200 is moved through the molten zinc bath 400 is (but not limited to) approximately 1 foot/minute.

In further embodiments, the rack 200 may be orientated at a slight angle, for example (but not limited to) 30 degrees, to facilitate removal of ash and dross out of the tubes 100. The rack 200 may be inserted into the molten zinc bath 400 at an angle, or the rack 200 may be orientated to such an angle while in the molten zinc bath 400. In other embodiments, the rack 200 may be orientated at any suitable angle as the rack 200 is moved through the molten zinc bath 100 that accounts for depth of the kettle 410 containing the molten zinc 420 and dross collecting at the bottom of the kettle 410.

As the rack 200 is moved through the molten zinc bath 400, ash usually rises to the surface of the molten zinc bath 400. Thus, in some embodiments, in step S1344, the surface of the molten zinc bath 400 is skimmed periodically to remove the ash accumulating on the surface of the molten zinc bath 400. For example, the surface of the molten zinc bath 400 is skimmed (but not limited to) sufficiently to remove most of the ash at the surface of the molten zinc bath 400 after each sweep of the rack 200 through the molten zinc bath 400.

With reference to FIGS. 1 and 5-7D, once the steel tubes 100 have remained in the molten zinc bath 400 sufficient time to equalize temperature of the steel tubes 100 with temperature of the molten zinc bath 400, the rack 200 is removed (in direction 248 in FIG. 7C) from the molten zinc bath 400 in step S136. In various embodiments, removing the rack 200 from the molten zinc bath 400 comprises removing the rack 200 substantially vertically from the molten zinc bath 400. If the rack 200 is not removed substantially vertically from the molten zinc bath 400, unwanted deposits, such as frozen zinc, may form within the tubes 100. These deposits, for instance, may hamper post-process chamfering and/or threading. Furthermore, these deposits or “burrs” may strip wiring or other conduits later placed within the tubes 100. Thus, in various embodiments, puddles of frozen zinc can be substantially prevented by removing the rack 200 substantially or completely vertical from the molten zinc bath 400. Furthermore, re-orientating the rack 200 into a substantially vertical position allows a thin uniformly concentric layer to form on the inside of the tubes 100.

Thus, various embodiments may allow for orientation of the rack 200 into a substantially vertical position from a submerged position that creates room to flush out ash by swinging the rack 200 beneath the molten zinc 420. In addition, such embodiments, may allow for improved drainage and improved retention of heat. In contrast to such embodiments, prior art methods, which include deep kettles in which a rack is placed completely vertically, do not provide enough clearance for the vertical rack to be moved up and down to displace ash or the like. As a result, such prior art methods require additional steps, such as blowing the insides of the tubes with superheated steam to remove the contents that could not be removed from the tubes while in the kettle.

FIG. 3 shows a flowchart of processing S1360 performed to remove the rack 200 from the molten zinc bath 400 according to an embodiment of the present invention. With reference to FIGS. 3 and 5-7E, in some embodiments, in step S1362, removing the rack 200 vertically comprises orientating the rack 200 (and the tubes 100 supported thereon) in a vertical position relative to the kettle 410 as the rack 200 is removed from the molten zinc bath 400 (e.g., FIG. 7D). For example, in some embodiments, the rack 200 may include a release mechanism configured to selectively attach and detach a portion of the rack 200 to the crane, which moves the rack 200 between each processing step, to allow the rack 200 (and the tubes 100 supported thereon) to rotate from a horizontally-tilted orientation to a vertical orientation as the rack 200 is withdrawn from the molten zinc bath 400.

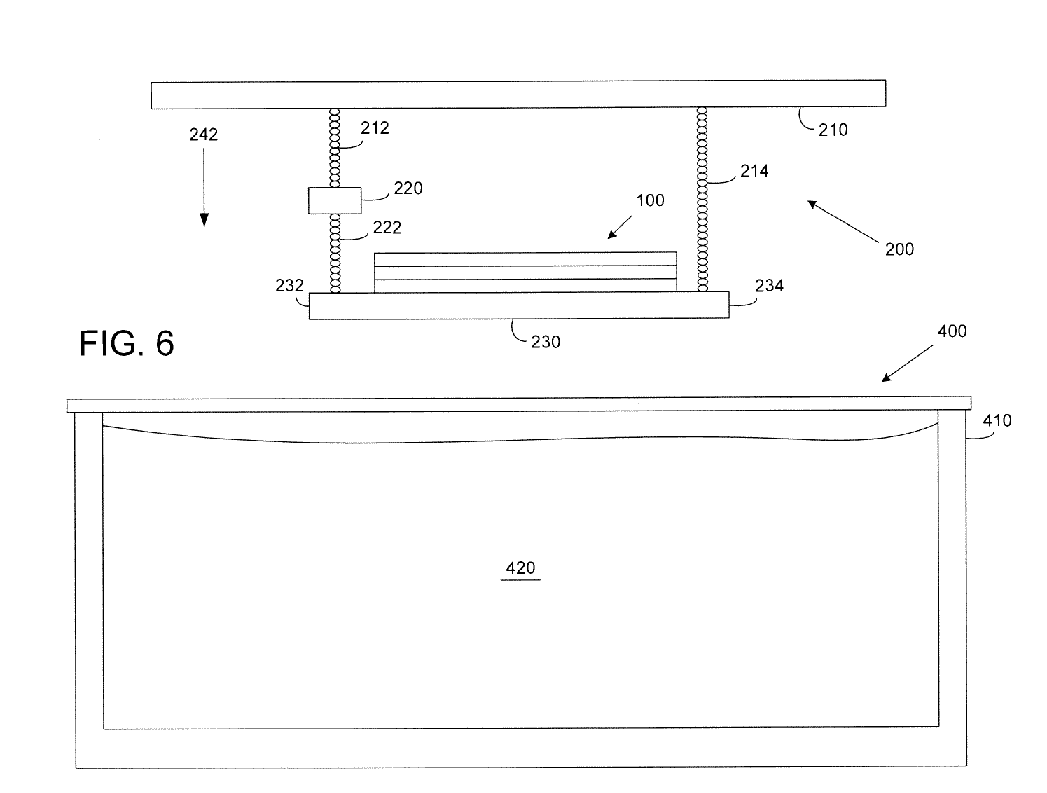

For example as shown in FIGS. 5 and 6, in particular embodiments, the rack 200 includes or is operatively connectable with a carriage 210 and a cross bar 220. A front end 234 of the bottom part 230 of the rack 200 is operatively connected to the carriage 210, for example with chains 214, wires, or the like. A back end 232 of a bottom part 230 of the rack 200 is operatively connected to the cross bar 220, for example, with chains 222, wires, or the like. The cross bar 220 is operatively connected to the carriage 210, for example with chains 212, wires, or the like. The carriage 210 is operatively connected to the crane.

In further embodiments, the cross bar 220 may be removably attachable from the carriage 210, for example, to allow the carriage 210 to be attachable to and detachable from the cross bar 220. The back end 232 of the bottom part 230 of the rack 200 may be configured to be removably attachable from the cross bar 220, for example, to allow the bottom part 230 of the rack 200 to be attachable to and detachable from the cross bar 220.

In particular embodiments, the cross bar 220 may include one or more pins, rods, or other fastening members 224 for removably attaching the cross bar 220 from the carriage 210. For example, by removing the fastening member 224, the carriage 210 may be released from the cross bar 220 to allow the carriage 210 to be raised relative to the cross bar 220. Likewise, the cross bar 220 may include one or more pins, rods, or other fastening members 226 for removably attaching the cross bar 220 from the bottom part 230 of the rack 200. For example, by removing the fastening member 226, the bottom part 230 of the rack 200 may be released from the cross bar 220 to allow the carriage 210 to raise the bottom part 230 of the rack 200, which orientates the rack 200 vertically relative to the kettle 410, as described in the disclosure. Accordingly, the rack 200 may be removed substantially vertically from the molten zinc bath 400. In other embodiments, such as in a case where the kettle 410 containing the molten zinc 420 has a depth that is greater than a length of the tubes 100, rotation of the rack 200 may be unnecessary because the rack 200 may be orientated vertically within the molten zinc bath 400 when the tubes 100 are placed in the molten zinc bath 400.

With reference to FIGS. 3 and 5-7E, in some embodiments, in step S1364, a rate at which the rack 200 is removed from the molten zinc bath 400 may be controlled. In particular, the rack 200 is raised from the molten zinc bath 400 at a controlled rate that allows time for sufficient drainage from the tubes 100, but does not allow crystallization to occur. In various embodiments, the rack 200 is removed at a rate between 3-20 feet/minute. For example, in at one least one embodiment, a period of 40 seconds lapses between a time when the top portions of the tubes 100 break the surface of the molten zinc 420 and the bottom portions of the tubes 100 is brought near the surface of the molten zinc 420 (as described below).

In particular embodiments, once removal of the rack 200 from the molten zinc bath 400 begins, the rack 200 should not be allowed to stop travelling vertically more than about 10 seconds. Otherwise, annular burrs may form on the tubes 100 that can damage wiring or other conduit later placed within the tubes 100. As will be discussed below, in other embodiments, once removal of the rack 200 from the molten zinc bath 400 begins, the rack 200 may be allowed to stop travelling vertically for a suitable amount of time (e.g., 10 or more seconds) in certain instances.

In some embodiments, the rack 200 is raised from the molten zinc bath 400 until the bottom portions of the tubes 100 (opposite the top portions of the tubes 100, which are the portions that first break the surface of the molten zinc 420 as the rack 200 is removed from the molten zinc bath 400) are brought near to the surface of the molten zinc 420, but not completely out of the molten zinc bath 400 (e.g., FIG. 7E). At such a point, in step S1366, removal of the rack 200 may be stopped temporarily to allow the bottom portion of the tubes 100 to remain in the molten zinc 420, for example, up to about 20 seconds. In particular preferred embodiments, the rack 200 may remain paused to allow the bottom portions of the tubes 100 to remain in the molten zinc 420 about 10 seconds.

Such embodiments may allow excess molten zinc to drain off the tubes 100 and/or may prevent air from entering into the hollow interior of the tubes 100 from the bottom of the tubes 100, which could result in air causing zinc to freeze within the tubes 100. In further embodiments, accumulation of zinc material on the bottom portions of the tubes 100 may be disregarded because the bottom portions will be threaded or otherwise manipulated during final stages of manufacturing. Thus, any defects that may result from allowing the bottom portions of the tubes 100 to remain in the molten zinc 420 may be acceptable.

In step S1368, the rack 200 and tubes 100 is completely removed from the molten zinc bath 400. Thus in various embodiments, the rack 200 is removed at a controlled rate and paused temporarily before being completely being removed from the molten zinc bath 400.

In further embodiments, the rate at which the rack 200 is removed from the molten zinc bath 400 may be varied as the rack 200 is removed from the molten zinc bath 400. For instance, in some embodiments, a first speed (e.g., 20 feet per minute) at which the rack 200 is initially raised from the molten zinc bath 420 (i.e., the top portions of the tubes 100 first break the surface of molten zinc 420) may be faster than a second speed (e.g., 3.5 feet per minute) at which an other portion of the rack 200 is raised from the molten zinc bath 400. For example, the crane (or other hoisting mechanism) may be configured to have two motors (e.g., having gear-box drives) and/or otherwise provide a first and second drive speed to raise the rack 200 initially at the first drive speed, and then raise the rack 200 at the second drive speed. In yet further embodiments, a transition between the first drive speed and the second drive speed may be minimized as much as possible, for example, to prevent the rack 200 from remaining still for too long while being removed from the molten zinc bath 400. In other embodiments, the crane may have any suitable number of motors and/or otherwise be configured to provide any number of drive speeds.

In other embodiments, the crane (or other hoisting mechanism) may be configured to have a variable speed control (i.e., one capable of changing speeds) (e.g., a variable frequency drive) to raise the rack 200 at a plurality of speeds. In such embodiments, the crane may be configured to raise the rack 200 at a first speed of the plurality of speeds initially and change to a second speed (e.g., a lower speed than the first speed), then a third speed (e.g., lower than the second speed), and so on as the rack 200 is raised from the molten zinc bath 400. For example, the crane may be configured to raise the rack 200 at (but not limited to) 20 feet per minute initially, then reduce the speed at which the rack 200 is being raised as the rack 200 is raised, then reduce the speed further to (but not limited to) 3.5 feet per minute. Thus, in various embodiments, the crane may be configured to raise the rack 200 at a plurality of different speeds. Such embodiments, for example, may allow for substantial drainage (e.g., at a low speed) of the molten zinc from the tubes 100 while minimizing heat loss from the tubes (e.g., at a high speed), which minimizes time for alloy crystals to form on the surface of the tubes.

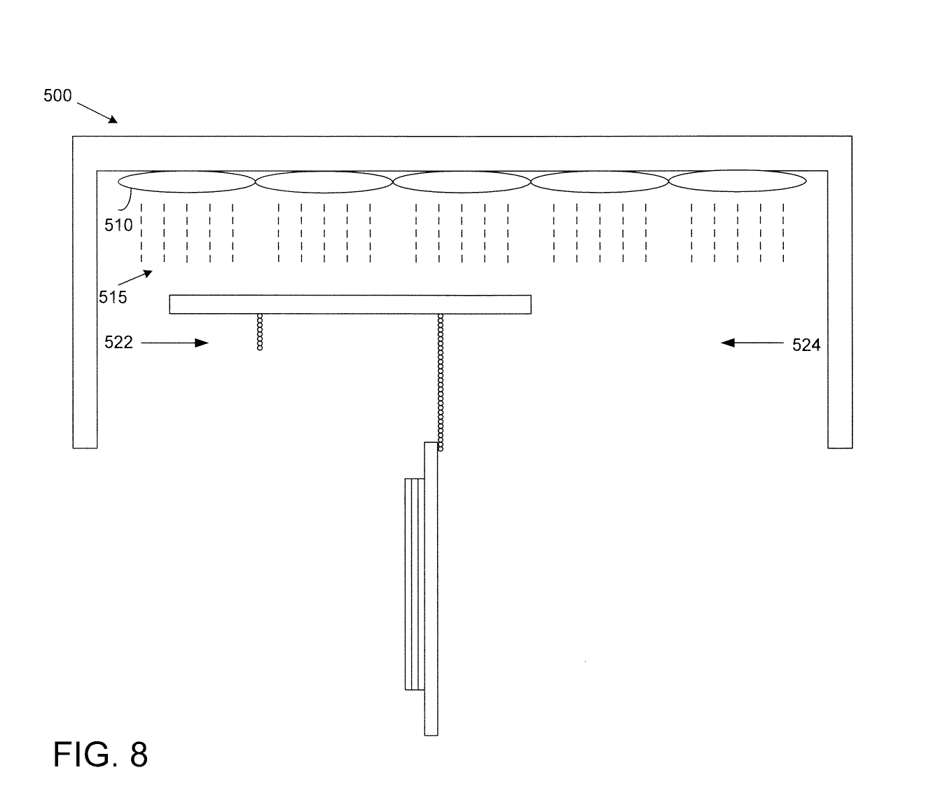

FIG. 8 is a side view cross-section of the rack 200 in a shower system 500 according to an embodiment of the present invention. With reference to FIGS. 1 and 8, once removed from the molten zinc bath 400, the rack may be conveyed to the shower system 500 or the like in order to be quenched within a short period (e.g., 30-90 seconds) after being fully removed from the molten zinc bath 400 to decrease the temperature of the tubes 100 to prevent or otherwise mitigate crystallization of the surface alloy of the tubes 100. In particular embodiments, the rack 200 is quenched within 60 seconds after removal from the molten zinc bath 400.

In various embodiments, in steps S142 and S144, the rack 200 is quenched by conveying the rack 200 and the tubes 100 supported thereon to the shower system 500. The tubes 100 of the rack 200 are allowed to cool in the shower system 500 anywhere from 10-60 seconds and/or to a temperature less than 500° F. In particular embodiments, the tubes 100 of the rack 200 are cooled by the shower system 500 for approximately 30-60 seconds and/or to approximately 400° F. In further embodiments, the shower system 500 may be configured to cool the tubes 100 of the rack 200 to a temperature less than 500° F., yet still minimize non-uniform stress to the tubes 100, which might otherwise occur if the temperature drop of the tubes 100 is too great. That is, the tubes 100 may be cooled to a temperature that would not produce too much non-uniform stress to the tubes 100. In various embodiments, the shower system 500 may provide (but not limited to) 600-1200 gallons/minute to each rack 200.

In various embodiments, the shower system 500 is configured to allow horizontal movement of the rack 200 along a traveling length of the shower system 500. Such horizontal movement allows more water 515 (or other coolant) from showerheads 510 to contact each of the tubes 100 to promote uniform cooling of the tubes 100. The rack 200 is moved in direction 522 along the traveling length of the shower system 500, for example, at (but not limited to) 30-90 feet/minute. In particular embodiments, the rack 200 is moved through the traveling length of the shower system 500 at approximately 50 feet/minute.

In some embodiments, the rack and/or the shower system may be configured such that the rack 200 passes through the shower system 500 repeatedly. In such embodiments, for example, the shower system 500 may have a traveling length between (but not limited to) 10-20 feet. In particular embodiments, for each pass through the shower system 500, the rack 200 may pass through and out of the shower system 500 before turning around and re-entering the shower system 500 for another pass. In other embodiments, the rack 200 may turn around in the shower system 500 (i.e., the rack 200 need not exit the shower system 500 to turn around) to complete another pass (in direction 524).

In yet other embodiments, the rack 200 and/or the shower system may be configured such that the rack 200 need only pass through the shower system 500 once to decrease the temperature of the tubes 100 adequately. For example, a shower system 500 having a traveling length that is sufficiently long such that the temperature of the tubes 100 may be decreased adequately with one pass may be employed.

In some embodiments, the shower system 500 may be configured to shower the tubes 100 of the rack 200 continuously as the tubes 100 pass through the shower system 500. In other embodiments, the shower system 500 may be configured to shower the tubes 100 of the rack 200 periodically. That is, in such embodiments, the tubes 100 are not showered as the rack 200 travels through certain portions of the shower system 500. In yet other embodiments, a ventilation device (not shown), such as a fan or the like, may be employed to promote airflow, which may promote uniform cooling of the tubes 100, in the shower system 500 as the rack 200 travels through the shower system 500.

The shower system 500 may be configured in any suitable manner that promotes uniform cooling of the tubes 100 of the rack 200. For example, water pumps, the shower nozzles 510, or the like may be arranged or otherwise positioned to promote homogenization of falling water 515 throughout the traveling length of the shower system 500.

Once the temperature of the tubes 100 have been decreased sufficiently (e.g., below 500° F.), the process S100 may be completed and/or the tubes 100 may be ready for further processing, for example, chamfering, threading, or the like.

With reference to FIGS. 1-8, in various embodiments, the rack 200 and steel tubes 100 supported thereon need not be placed in an alkaline bath prior to placement in the acid bath 200, for example, in a case where the tubes 100 are manufactured in a controlled manner to ensure that the tubes 100 are substantially free of organic materials. As another example, this step may be omitted in a case where the tubes 100 are cleansed of organic materials prior to the molten zinc bath 400. In other embodiments, the rack 200 and steel tubes 100 may be placed in an alkaline bath if desired.

In various embodiments, the rack 200 may include a pair of rests for holding each respective end of the tubes 100. Such embodiments may avoid marking the tubes 100 at any location other than where the rests contact the tubes 100 (i.e., the ends of the tubes 100). In particular embodiments, marking at the ends of the tubes 100 may be disregarded because the ends will be stripped and threaded during further manufacturing and processing of the tubes 100.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A method for hot-dip galvanizing metal tubes, the method comprising:
placing a rack of metal tubes in an acid bath;
removing the rack of metal tubes from the acid bath;
placing the rack of metal tubes in a molten bath;
removing the rack of metal tubes from the molten bath; and
quenching the rack of metal tubes in a shower;
wherein the rack of metal tubes is placed in the molten bath immediately after the rack is removed from the acid bath without further processing therebetween.

2. The method of claim 1, wherein the rack of metal tubes is placed in the molten bath without being placed in a flux bath after the rack is removed from the acid bath.

3. The method of claim 1, wherein the metal tubes are made of a material comprising steel.

4. The method of claim 3, wherein the steel comprises approximately less than 0.06% silicon.

5. The method of claim 3, wherein the steel comprises approximately less than 0.04% silicon.

6. The method of claim 1, wherein the molten bath is a molten zinc bath.

7. The method of claim 1, the method further comprising:
moving the rack of metal tubes through the molten bath in a swinging motion.

8. The method of claim 1, wherein the rack of metal tubes is moved in a direction parallel to an axial direction of the tubes.

9. The method of claim 1, wherein removing the rack of metal tubes from the molten bath comprises rotating the rack to be substantially vertical relative to the molten bath during removal of the rack from the molten bath.

10. The method of claim 1, wherein removing the rack of metal tubes from the molten bath comprises rotating the rack to be substantially vertical relative to the molten bath before removal of the rack from the molten bath.

11. The method of claim 1, wherein removing the rack of metal tubes from the molten bath comprises removing a first portion of the rack of metal tubes at a first speed different from a second speed at which a second portion of the rack of the metal tubes is removed from the molten bath.

12. The method of claim 1, wherein removing the rack of metal tubes from the molten bath comprises:
removing the rack of metal tubes from the molten bath until bottom portions of the metal tubes are brought near the surface of the molten bath; and
pausing removal of the rack of metal tubes from the molten bath while the bottom portions of the metal tubes are near the surface of the molten bath; and
removing the bottom portions of the metal tubes from the molten bath.

13. The method of claim 1, the method further comprising:
moving the rack of metal tubes through the molten bath;
wherein the rack of metal tubes is oriented to be non-parallel to the molten bath.

14. The method of claim 1,
wherein removing the rack of metal tubes from the molten bath comprises completely removing the rack of metal tubes from the molten bath; and
wherein the rack of metal tubes is quenched in the shower within 90 seconds after the rack of metal tubes is completely removed from the molten bath.

15. The method of claim 1, wherein quenching the rack of metal tubes in the shower comprises moving the rack of metal tubes through the shower.

16. The method of claim 1, wherein quenching the rack of metal tubes in the shower comprises showering the rack of metal tubes with water.

17. A hot-dip galvanizing system, the method comprising:
an acid bath for receiving a rack of metal tubes;
a molten bath for receiving the rack of metal tubes after being removed from the acid bath; and
a shower system for quenching the rack of metal tubes after being removed from the molten bath;
wherein the rack of metal tubes is placed in the molten bath immediately after the rack is removed from the acid bath without further processing therebetween.

18. A method for hot-dip galvanizing metal tubes, the method comprising:
a placing means for placing a rack of metal tubes in an acid bath;
a removing means for removing the rack of metal tubes from the acid bath;
a placing means for placing the rack of metal tubes in a molten bath;
a removing means for removing the rack of metal tubes from the molten bath; and
a quenching means for quenching the rack of metal tubes in a shower;
wherein the rack of metal tubes is placed in the molten bath immediately after the rack is removed from the acid bath without further processing therebetween.
